(19) United States
(12) Patent Application Publication
(10) Pub. No.: US 2004/0036897 A1
(43) Pub. Date: Feb. 26, 2004

(54) Image processing apparatus, image processing method and image processing program

(75) Inventor: Yasuki Yamauchi, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/443,968

(22) Filed: May 23, 2003

(30) Foreign Application Priority Data
Aug. 20, 2002 (JP) 2002-239965
Mar. 24, 2003 (JP) 2003-080997

(51) Int. Cl. G06K 15/14

(52) U.S. Cl. 358/1.9

(57) ABSTRACT

An image processing apparatus for processing image information to form an embossed print image by transferring an image with an expandable toner and an image with a nonexpandable toner onto a recording medium and fixing the expandable toner and the nonexpandable toner, which are transferred onto the recording medium, to the recording medium, comprising a total toner amount recognition unit which recognizes the total toner amount of an expandable toner amount and a nonexpandable toner amount used for formation of an image in a unit of prescribed amount, and an image processing unit which performs image processing of image information to reduce the toner amount used for formation of the image when the total toner amount recognized by the recognition unit exceeds a prescribed amount.

### BACKGROUND OF THE INVENTION

1. Field of the Invention

The present invention relates to an image processing apparatus, an image processing method and an image processing program for forming an embossed print image by transferring an image with an expandable toner and an image with a nonexpandable toner onto a recording medium according to image information and utilizing thermal expansion of the expandable toner.

2. Description of the Related Art

Conventionally known technologies to form an embossed image on a recording medium such as recording paper employ emboss processing, dot impacting, expandable paper or thermal-transfer films, etc.

However, the above-mentioned conventional technologies have drawbacks in view of costs, durability, preservability and the like and are being used for limited purposes only.

Accordingly, the present applicant has proposed image processing apparatuses for forming embossed images using an expandable toner in Japanese Patent Application Laid-open Publication No. 2000-131875 (Title of the invention: Image forming toner, its formation method, a method of forming an embossed image using the toner and image formation apparatus) and in Japanese Patent Application Laid-open Publication No. 2001-194846 (Title of the invention: Image formation apparatus).

The technologies disclosed in the above publications use the expandable toner to make it possible to inexpensively and easily form embossed images excelling in durability, preservability and the like by a common electrophotographic printer, a copy machine and the like.

However, such technologies can simply form monochrome embossed images but cannot form full-color embossed images.

When a full-color embossed image is formed with expandable toners, the full-color embossed image cannot be formed by simply superposing plural expandable toners containing different coloring materials and transferring onto a recording medium. The reason is that because the expandable toners in the expanded state do not have enough light transmissivity.

In view of the above, the present applicant has proposed a configuration for forming less-expensively a full-color embossed image excelling in durability, preservability and the like by transferring the expandable toner onto a recording medium and also transferring nonexpandable toners having respective colors onto the expandable toner.

When configured as described above, however, multiple transfer is performed to transfer plural toner images when the toner image is transferred onto an intermediate transfer unit or a recording medium.

If a transfer current value becomes smaller than a prescribed reference value in the multiple transfer, a transfer rate lowers, and if it is larger than the reference value, the transferred image has deterioration in image quality, such as blur.

Especially, since the expandable toner for forming an embossed print image has low light transmissivity, it is required to form an expandable toner layer directly on the recording medium such as paper at the final stage of printing.

Therefore, when the multiple transfer is made onto the intermediate transfer unit, the expandable toner should be transferred in the last stage.

In such a case, the toner amount of a given pixel on the intermediate transfer unit may exceed the maximum amount of ordinary four-color toners, depending on information about the expandable toner.

Therefore, when a toner in an amount exceeding the maximum value of the ordinary four-color toners is transferred onto the intermediate transfer unit or the recording medium, a larger current value is required than that for ordinary printing to improve the transfer rate. However, there is a drawback that image quality is deteriorated.

Accordingly, in an embossed print processing using an expandable toner, the present invention intends to provide an image processing apparatus, an image processing method and an image processing program by which a total amount of color toners and an expandable toner to be formed on an intermediate transfer unit does not exceed a prescribed value regardless of a type of print image and image quality is suppressed from being deteriorated.

### SUMMARY OF THE INVENTION

The present invention has been made to remedy the above drawbacks, and an aspect of the invention provides an image processing apparatus for processing image information to form an embossed print image by transferring an image with an expandable toner and an image with a nonexpandable toner onto a recording medium and fixing the expandable toner and the nonexpandable toner to the recording medium, comprising: a total toner amount recognition unit which recognizes a total toner amount of an expandable toner amount and a nonexpandable toner amount used for formation of an image in a unit of prescribed amount; and an image processing unit which performs image processing of the image information to reduce the toner amount used for formation of the image when the total toner amount recognized by the recognition unit exceeds a prescribed amount.

Another aspect of the invention provides an image processing method for processing of image information to form an embossed image by transferring an image with an expandable toner and an image with a nonexpandable toner onto a recording medium and fixing the expandable toner and the nonexpandable toner to the recording medium, comprising: recognizing a total toner amount of an expandable toner amount and a nonexpandable toner amount used for formation of an image in a unit of prescribed amount by a total toner amount recognition unit; and performing image processing of the image information to reduce the toner amount used for the image formation when the total toner amount recognized by the total toner amount recognition unit exceeds a prescribed amount.

A still another aspect of the present invention provides an image processing program for processing image information to form an embossed print image by transferring an image with an expandable toner and an image with a nonexpandable toner onto a recording medium and fixing the expandable toner and the nonexpandable toner, which are transferred onto the recording medium, to the recording medium, comprising: a step of recognizing a total toner amount of an expandable toner amount and a nonexpandable toner amount used for formation of an image in a unit of prescribed amount; and a step of performing image processing of the image information to reduce the toner amount used for formation of the image when the total toner amount exceeds a prescribed amount.

According to the invention, in the embossed print processing using the expandable toner, the total amount of the color toners and the expandable toner formed on the intermediate transfer unit is adjusted so as not to exceed a prescribed value regardless of a type of print image, whereby it is possible to provide the embossed print image with its image quality suppressed from being degraded.

### BRIEF DESCRIPTION OF THE DRAWINGS

Preferred embodiments of the present invention will be described in detail based on the following figures, wherein:

FIG. 1 is a structure diagram showing an inside structure of the image processing apparatus according to the present invention;

FIG. 2 is a control block diagram showing a first configuration of control of an image processing section in the image processing apparatus according to the present invention;

FIG. 3A to FIG. 3D are conceptual diagrams showing a pattern of processing for reduction of the total toner amount according to the present invention;

FIG. 4A and FIG. 4B are conceptual diagrams of processing for reduction of the total toner amount in YMCK color presentation by UCR (Under Color Removal) according to the present invention;

FIG. 5 is a flow chart showing a procedure of processing for recognition of the total toner amount according to the present invention;

FIG. 6 is a flow chart showing processing for adjustment of a nonexpandable toner amount according to the present invention;

FIG. 7 is a flow chart showing processing for adjustment of an expandable toner amount according to the present invention;

FIG. 8 is an image of a user interface used by a user to give priority in the toner adjustment processing according to the present invention;

FIG. 9 is a flow chart showing a procedure of toner processing according to the priority designated by a user in the toner adjustment processing according to the present invention;

FIG. 10 is a block diagram showing a second configuration of control of the image processing section in the image processing apparatus according to the present invention;

FIG. 11 is a flow chart showing a procedure of processing for automatic adjustment of a toner amount according to an image type (for example, a photograph or a figure/character image) in the second configuration of control of the image processing section in the image processing apparatus according to the present invention;

FIG. 12 is a control block diagram showing a third configuration of control of the image processing section in the image processing apparatus according to the present invention;

FIG. 13 is a flow chart showing a procedure of processing for automatic adjustment of a toner amount according to an image type (a monochrome image or a color image) in the third configuration of control of the image processing section in the image processing apparatus according to the present invention;

FIG. 14 is a control block diagram showing a fourth configuration of control of the image processing section in the image processing apparatus according to the present invention;

FIG. 15 is a flow chart showing a procedure of processing for automatic adjustment of a toner amount according to image forming conditions for a recognized image type in the fourth configuration of control of the image processing section in the image processing apparatus according to the present invention; and

FIG. 16 is a flow chart showing an algorithm of a function at the time of reducing a nonexpandable toner amount and an expandable toner amount according to a predetermined function in processing the automatic adjustment of the toner amount in the image processing apparatus according to the present invention.

### DESCRIPTION OF THE PREFERRED EMBODIMENTS

Embodiments of the image processing apparatus and the image processing method according to the present invention will be described in detail with reference to the accompanying figures.

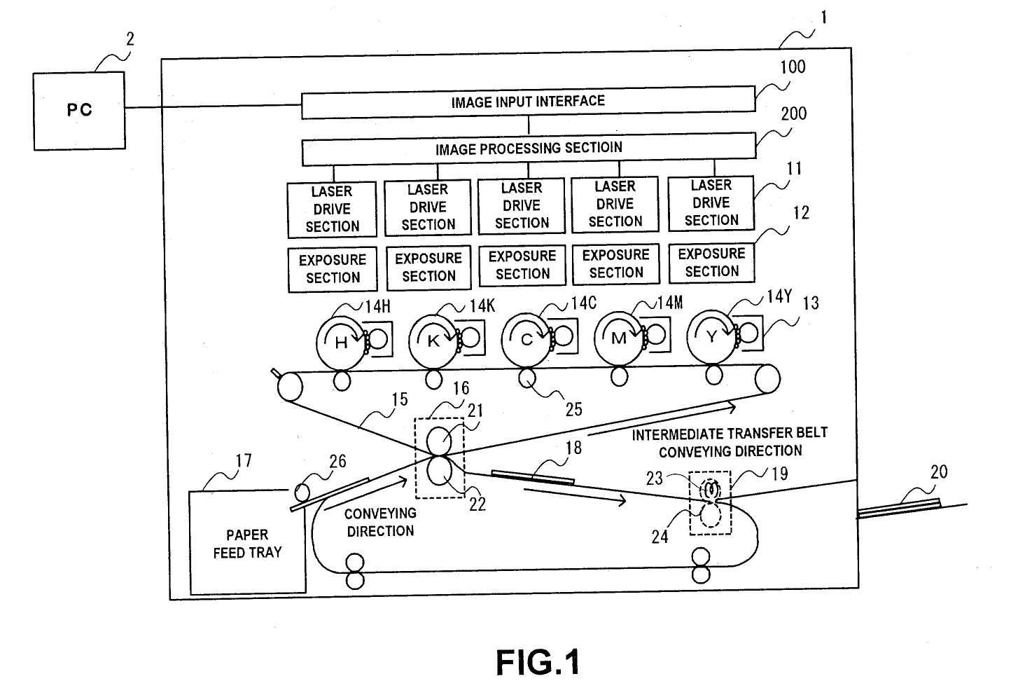

FIG. 1 shows an inside structure of an image processing apparatus 1.

Here, the image processing apparatus of the present invention indicates fundamentally an apparatus which is configured to be operable independent of an image formation apparatus for forming an embossed image. In the embodiments to be described below, the entire configuration including the image formation apparatus is called as the image processing apparatus, and a component corresponding to the image processing apparatus of the present invention is assumed to be an image processing section 200 and will be described below.

Image information prepared and edited by a PC (personal computer) 2 is sent to the image processing apparatus 1 via an image input interface section 100 and subjected to prescribed image processing such as shading correction, displacement correction, brightness/color space conversion, gamma correction, frame removal, color/luminance editing or the like in the image processing section 200.

Image processing for calculating height information is performed to form an embossed image with the expandable toner.

And, the image information undergone the prescribed image processing by the image processing apparatus 1 is converted into four-color original coloring material tone data of yellow (Y), magenta (M), cyan (C), black (K) and also into image height (H) data and sent to respective laser drive sections 11. Each of the five data is represented in eight (8) bits.

The respective laser drive sections 11 expose an image by a laser beam according to original color data via exposure sections 12.

The image processing apparatus 1 has therein the laser drive sections 11, the exposure sections 12 for exposure of an image irradiated by a laser beam, photosensitive drums 14Y to 14H as image carriers on which electrostatic latent images are formed, and a developing unit which can develop the electrostatic latent images formed on the photosensitive drums 14Y to 14H to form plural toner images having different colors.

The laser drive section 11 emits a laser beam on the basis of a pulse signal modulated according to the original reproduction coloring material tone data.

The photosensitive drums 14Y to 14H which are scanned and exposed by the exposure sections 12 with laser beams emitted by the laser drive sections 11 are driven to rotate at a prescribed speed in an arrow direction.

And, the electrostatic latent images of the exposed images previously electrized to a prescribed polarity (e.g., a negative polarity) and potential and irradiated by the exposure sections 12 are formed on the surfaces of the photosensitive drums 14Y to 14H.

The electrostatic latent images formed on the respective photosensitive drums 14 are developed reversely with, for example, toners which are electrized to the same negative polarity as the electrized polarity of the photosensitive drums 14Y to 14H to form toner images having prescribed colors and height by the photosensitive drum (Y) 14Y, photosensitive drum (M) 14M, photosensitive drum (C) 14C and photosensitive drum (K) 14K for individually developing four colors of yellow (Y), magenta (M), cyan (C) and black (K) and the photosensitive drum (H) 14H for developing image height.

At this time, for example, −500V developing bias voltage is applied to the photosensitive drum (Y) 14Y, the photosensitive drum (M) 14M, the photosensitive drum (C) 14C, the photosensitive drum (K) 14K and the photosensitive drum (H) 14H.

The toner images formed on the photosensitive drums 14Y to 14H are multi-transferred onto an intermediate transfer belt 15, which is disposed as an intermediate transfer unit below the photosensitive drums 14Y to 14H, by primary transfer rolls 25 as first transfer units.

The intermediate transfer belt 15 is supported to be rotatable in an arrow direction at the same moving speed as the peripheral speeds of the photosensitive drums 14Y to 14H by a drive roll (not shown), a driven roll (not shown), a tension roll (not shown), and a backup roll 21 as an opposite roll configuring a part of a secondary transfer unit.

All or a part of the toner images of yellow (Y), magenta (M), cyan (C), black (K) and height (H) formed on the photosensitive drums 14 are transferred in a state sequentially superposed by the primary transfer rolls 25 onto the intermediate transfer belt 15 according to the colors of the image to be formed.

The toner image transferred onto the intermediate transfer belt 15 is transported to a secondary transfer section 16 in prescribed timing and transferred by pressure-contact force and electrostatic attraction of the backup roll 21 which supports the intermediate transfer belt 15 and a secondary transfer roll 22 which is forced to contact to the backup roll 21.

Embossed image recording paper 18 having a prescribed size is fed by a feed roll 26 from multiple paper-feeding trays 17 which are disposed at a lower part in the image processing apparatus 1.

The fed embossed image recording paper 18 is transported to the secondary transfer section 16 with prescribed timing by multiple transport rolls (not shown) and resist rolls (not shown).

And, the toner images having prescribed colors are collectively transferred from the intermediate transfer belt 15 by the backup roll 21 and the secondary transfer roll 22 as the secondary transfer unit.

The embossed image recording paper 18 onto which the toner image having prescribed colors transferred from the intermediate transfer belt 15 is separated from the intermediate transfer belt 15 and transported to a fixing section 19. The toner image is fixed onto the embossed image recording paper 18 under heat and pressure by a heat roll 23 and a pressure roll 24 of the fixing section 19, and the embossed image recording paper 18 is discharged to a stacker 20 of the image processing apparatus 1. And, the embossed color image formation process is terminated.

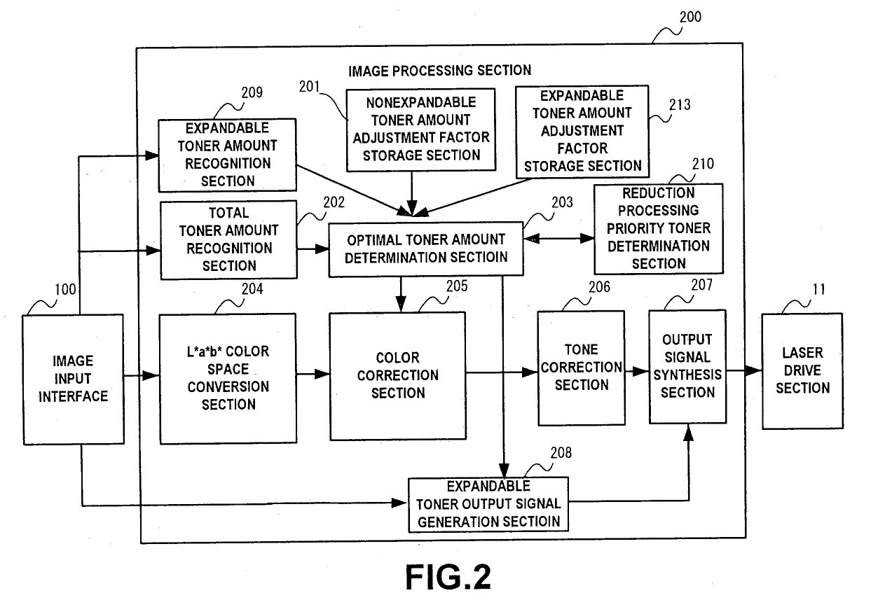

Then, the first configuration of control of the image processing section 200 in the image processing apparatus 1 will be described with reference to the block diagram of FIG. 2.

The image information received via the image input interface 100 is sent to four control blocks, an expandable toner amount recognition section 209, a total toner amount recognition section 202, an L*a*b* color space conversion section 204 and an expandable toner output signal generation section 208.

Image processing of an input image which does not need the optimization of a toner amount performs color conversion of the color information about each pixel indicated by RGB of the input image information to an L*a*b* signal by the L*a*b* color space conversion section 204.

The L*a*b* color signal processed by the L*a*b* color space conversion section 204 is subjected to color conversion and color correction by a color correction section 205 in compliance with the properties of the image processing apparatus 1 so to be converted to four YMCK color signals and output to a tone correction section 206.

The tone correction section 206 corrects the tone in compliance with the property of the image processing apparatus and outputs a signal for obtaining toner amounts of the corrected four colors of YMCK to an output signal synthesis section 207.

Meanwhile, when it is necessary to adjust the toner amount, the expandable toner amount recognition section 209 calculates an expandable toner amount of each pixel from the image information and outputs data to an optimal toner amount determination section 203.

The total toner amount recognition section 202 calculates for each pixel the total toner amount of four YMCK color toners and expandable toner obtained from the image information and outputs data to the optimal toner amount determination section 203.

A reduction processing priority toner determination section 210 outputs previously set determination conditions or processing conditions determined according to the designation made by the user for reduction of an amount of which of the expandable toner or the nonexpandable toner with priority to the optimal toner amount determination section 203. The optimal toner amount determination section 203 judges the presence or not of pixels exceeding the maximum permitted amount according to the recognition results notified by the total toner amount recognition section 202.

If there are pixels with the total toner amount exceeding the maximum permitted amount, the maximum value notified from the expandable toner amount recognition section 209 is considered, an ups-and-downs relationship between the respective pixels of the entire image is held, an expandable toner amount adjustment factor with which the total toner amount of the pixels having the maximum expandable toner amount becomes the maximum permitted amount or below is obtained from an expandable toner amount adjustment factor storage section 213. And, an adjustment signal is sent to the expandable toner output signal generation section 208.

Meanwhile, to reduce the nonexpandable toner amount, a UCR rate (the adjustment value necessary for reduction of the total amount of the nonexpandable toners by partly replacing toners among the three YMC color toners with the black color toner) to have the total toner amount in the maximum permitted amount or below is obtained from a nonexpandable toner amount adjustment factor storage section 201 and output to the color correction section 205.

Here, for the pixels of which output signal adjustment is instructed by the expandable toner amount adjustment signal from the optimal toner amount determination section 203, the output signal is compensated according to the received adjustment signal and sent to the output signal synthesis section 207.

The output signal synthesis section 207 modulates the YMCK color signals generated by the heretofore-made conversion processing and the signal indicating the expandable toner amount to generate a pulse signal for determination of an irradiation of the laser beam by the laser drive section 11.

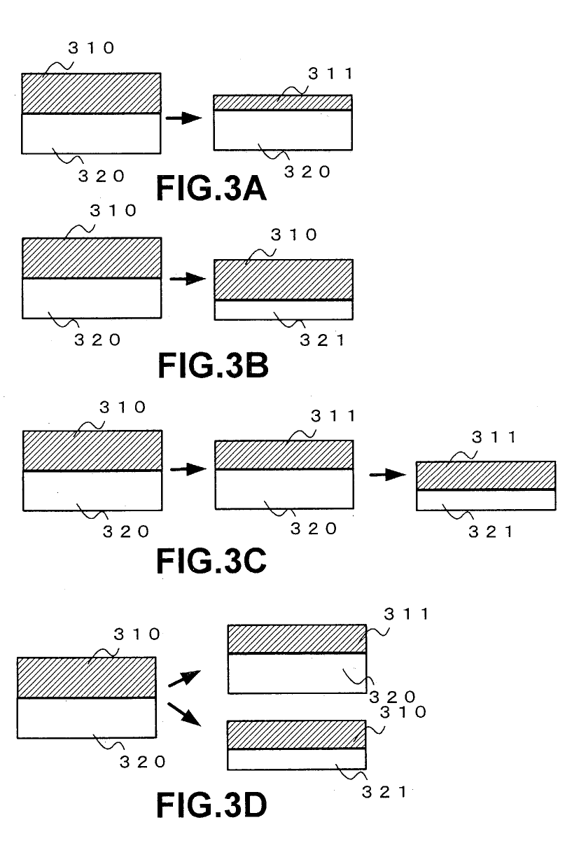

Then, a pattern of processing for optimization of the total toner amount by the image processing apparatus 1 will be described with reference to the conceptual diagrams of FIGS. 3A to 3D.

In the figures, white areas indicate the expandable toner, and hatched areas indicate the nonexpandable toner.

The total toner amount used for each pixel is reduced as indicated in the four patterns of FIG. 3A to FIG. 3D.

The first pattern is to reduce a nonexpandable toner amount 310 by UCR or the like to obtain a nonexpandable toner amount 311 as shown in FIG. 3A.

The second pattern is to obtain an expandable toner amount 321 by reducing an expandable toner amount 320 by an expandable toner amount adjustment factor determined by prescribed weighting with respect to the entire image as shown in FIG. 3B.

The third pattern is, as shown in FIG. 3C, to reduce both the nonexpandable toner amount and the expandable toner amount as in FIGS. 3A and 3B.

And, the fourth pattern selects the first pattern of FIG. 3A and the second pattern of FIG. 3B as shown in FIG. 3D or applies according to the priority.

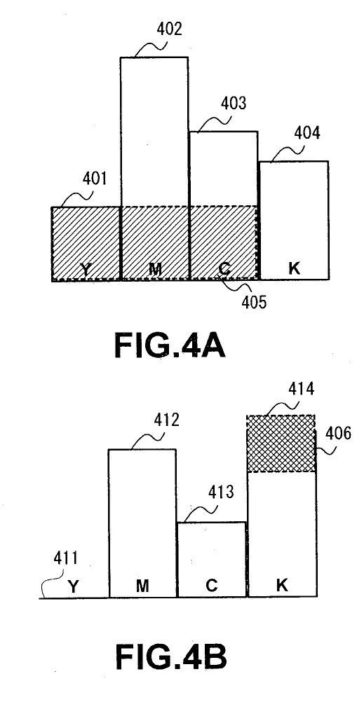

The reduction processing of the nonexpandable toner amount shown in FIG. 3A will be described with reference to the image diagrams of FIG. 4A and FIG. 4B.

The figures show models of the YCMK toner amount when given colors are shown without UCR (FIG. 4A) and the respective YMCK toner amounts after UCR (FIG. 4B).

The UCR is a method of decreasing YMC color components by partly replacing the YMC color signals with the K-color signal.

Specifically, it is a method to reduce YMC mixed color components at the time of printing by replacing a portion corresponding to the gray component in the YMC with black dots, namely a K component.

The figures show that Y-color toner 401, M-color toner 402 and C-color toner 403 each are reduced to adjusted Y-color toner 411, adjusted M-color toner 412 and adjusted C-color toner 413 by presenting YMC color mixed portion 405 with a gray replacement section 406 by a K-color toner, adjusted K-color toner 414 is increased to be larger than K-color toner 404 by the gray replacement section 406, but the total toner amount of the adjusted Y-color toner 411, the adjusted M-color toner 412, the adjusted C-color toner 413 and the adjusted K-color toner 414 becomes smaller than in FIG. 4A.

Then, processing for recognition of the total toner amount by the total toner amount recognition section 202 in the image processing section 200 in the control block diagram shown in FIG. 1 will be described.

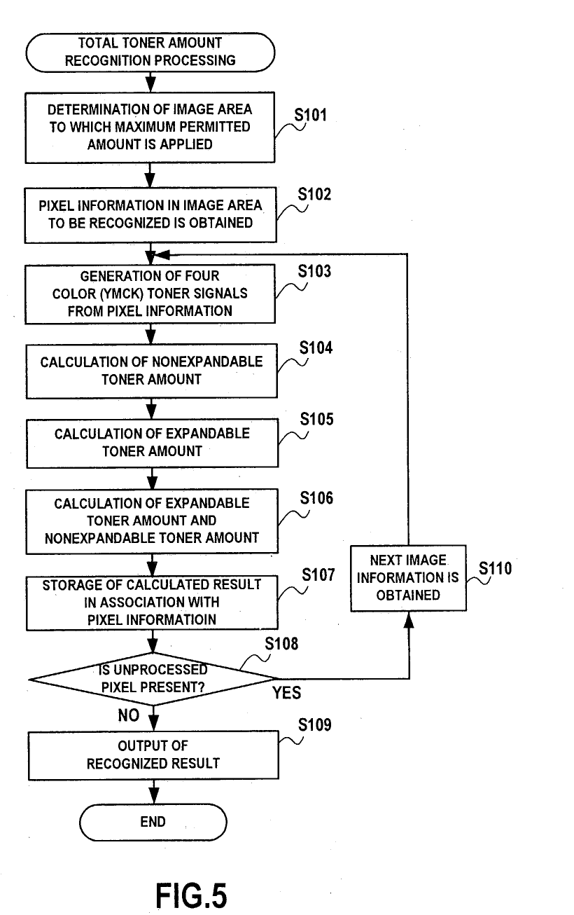

FIG. 5 is a flow chart showing the procedure of processing for recognition of the total toner amount.

The expandable toner amount recognition section 209 receives image information through the image input interface 100 to determine an image area to which the regulation of an available toner amount is applied (step S101).

The information (including color information) on each pixel in the determined image area is sequentially obtained from the image information (step S102).

Four color (YMCK) toner signals are generated from the obtained pixel color information (step S103).

The toner amount corresponding to each color component is calculated from the generated four-color toner signals, and the total nonexpandable toner amount is calculated (step S104).

The expandable toner amount to be determined according to the four-color toner signals or height information previously contained in the image information is calculated (step S105).

Besides, the total toner amount of the nonexpandable toner amount and the expandable toner amount is calculated (step S106), and the calculated result is stored in association with the pixel information (step S107).

If there still remains an unprocessed pixel (YES in step S108), the next pixel information is obtained (step S110), and processing from step S103 to step S107 is repeated.

When the recognition processing of all the pixels is completed (NO in step S108), the recognized result is sent to the optimal toner amount determination section 203 (step S109).

Then, processing for reduction of the nonexpandable toner amount by the optimal toner amount determination section 203 will be described.

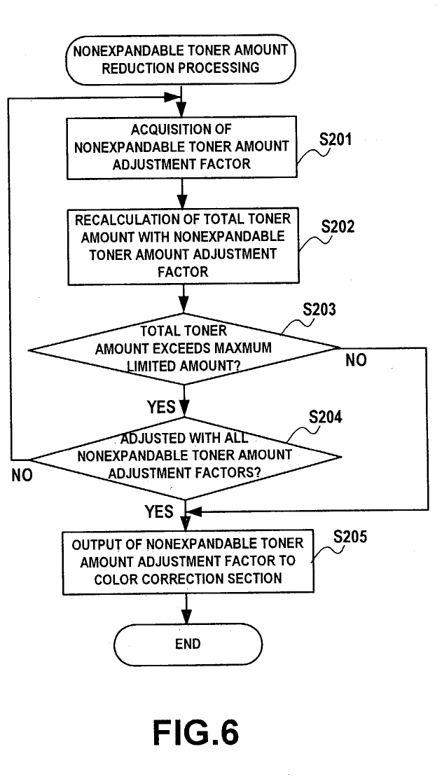

FIG. 6 is a flow chart showing a procedure of processing for reduction of the nonexpandable toner amount.

The invention will be described assuming that the recognition result from the total toner amount recognition section exceeds the maximum permitted amount.

The optimal toner amount determination section 203 obtains a nonexpandable toner amount adjustment factor for carrying out UCR to nonexpandable toner from the nonexpandable toner amount adjustment factor storage section 201 (step S201).

The nonexpandable toner amount is recalculated with the four-color toner signals for respective pixels of the subject image area corrected by the obtained nonexpandable toner amount adjustment factor, and the total toner amount is recalculated (step S202).

When the total toner amount does not exceed the maximum permitted amount in all the pixels to be processed (NO in step S203), the current nonexpandable toner amount adjustment factor is sent to the color correction section 205 (step S205).

Meanwhile, when there are pixels exceeding the maximum permitted amount (YES in step S203) and an unused nonexpandable toner amount adjustment factor for reducing the nonexpandable toner amount is still in the nonexpandable toner amount adjustment factor storage section 201 (NO in step S204), processing from step S201 to step S203 is repeated.

Then, processing for reduction of the expandable toner amount shown in FIG. 3B will be described.

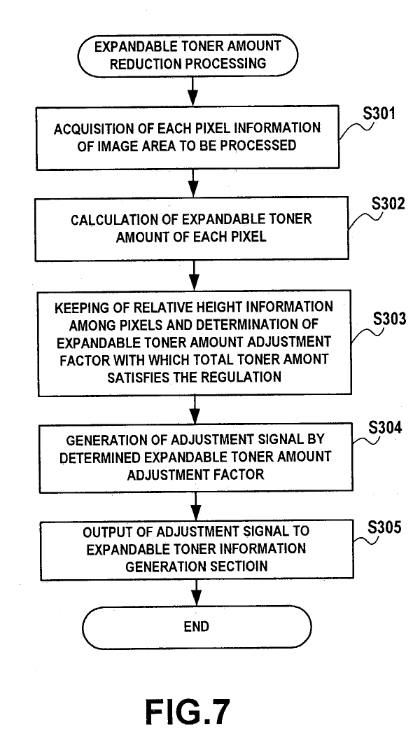

FIG. 7 is a flow chart showing a procedure of processing for reduction of the expandable toner amount.

Here, this flow chart will be described assuming that the image to be processed has pixels with the total toner amount exceeding the maximum permitted amount.

The expandable toner amount recognition section 209 obtains each piece of pixel information about the image area to be processed from the image information received through the image input interface 100 (step S301).

The expandable toner amount is calculated for every pixel according to color information included in the obtained pixel information or the designated height information and sent to the optimal toner amount determination section 203 (step S302).

The optimal toner amount determination section 203 keeps the relative height information among pixels in the entire image area according to the recognized result by the expandable toner amount recognition section 209 and determines an expandable toner amount adjustment factor for reducing the expandable toner amount by weighting so to make the total toner amount equal to or less than the maximum permitted amount (step S303).

An adjustment signal for compensation of the expandable toner amount of each pixel is generated by the determined expandable toner amount adjustment factor (step S304) and sent to the expandable toner output signal generation section 208 (step S305).

Then, in the toner amount optimization processing, performance of a combination of the nonexpandable toner reduction processing and the expandable toner reduction processing or performance of processing with one of them with higher priority as shown in FIG. 3C and FIG. 3D will be described.

Priority conditions for performance of either the nonexpandable toner amount or the expandable toner amount with higher priority include that the reduction processing priority toner determination section 210 shown in, for example, FIG. 2 complies with the predetermined image formation conditions or the instructions given by the user.

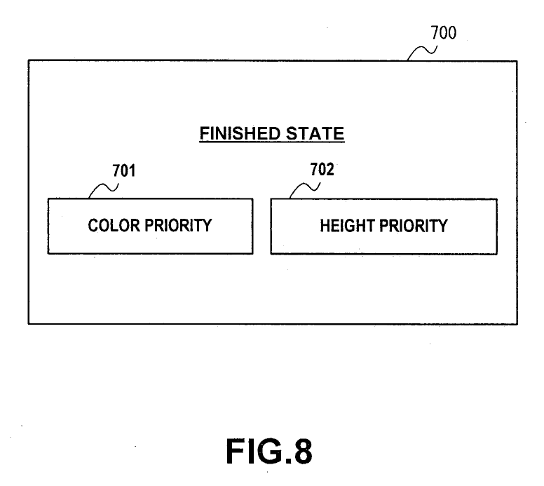

When the priority conditions are designated by the user, the priority conditions are designated through a user interface 700 for selection of a “color priority button” 701 or a “height priority button” 702 as a finished state as shown in, for example, FIG. 8

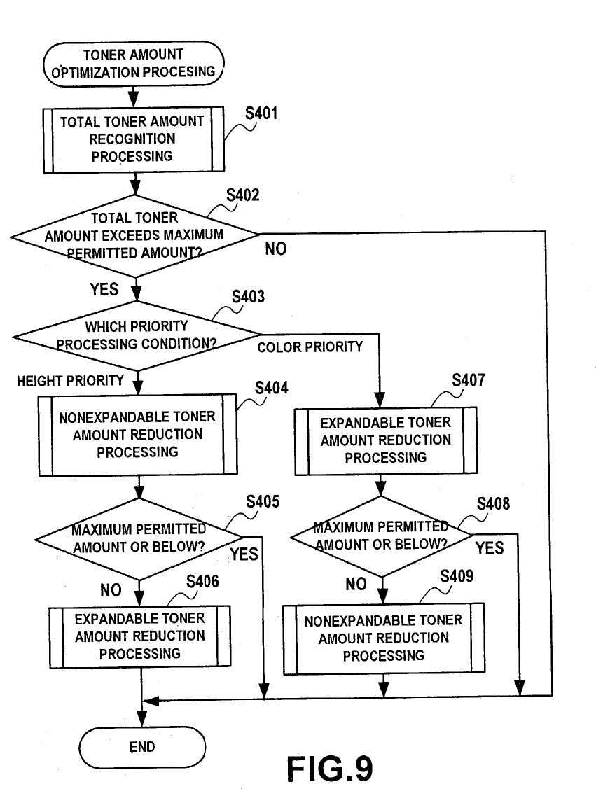

FIG. 9 is a flow chart showing processing for reduction of the total toner amount according to the determined priority conditions.

The total toner amount recognition section 202 recognizes the total toner amount of each pixel in the subject area from the image information (step S401).

If there is a pixel with total toner amount exceeding the maximum permitted amount (YES in step S402), the toner to be preferentially reduced is determined according to the priority conditions determined by the reduction processing priority toner determination section 210 (step S403).

When the priority conditions for preferential reduction of the nonexpandable toner amount is selected (height priority in step S403), the nonexpandable toner amount reduction processing is performed (step S404).

When the nonexpandable toner amount reduction processing results in that there still remains a pixel with the total toner amount exceeding the maximum permitted amount (YES in step S405), the expandable toner amount reduction processing is performed (step S406).

Meanwhile, when the priority conditions for preferential reduction of the expandable toner amount is selected (color priority in step S403), the expandable toner amount reduction processing is performed (step S407).

When the expandable toner amount reduction processing results in that there remains a pixel with the total toner amount exceeding the maximum permitted amount (YES in step S408), the nonexpandable toner amount reduction processing is performed (step S409).

In the priority condition determination processing in step S403, it is also possible to configure so to designate the priority of colors and height by specific numerical values other than the user interface shown in FIG. 8.

In the reduction processing of the nonexpandable toner amount and the expandable toner amount, it is also possible to add a user interface to directly specify the nonexpandable toner amount adjustment factor and the expandable toner amount adjustment factor by the user so to reduce the total toner amount according to the input value.

Then, some modified embodiments other than the total toner amount reduction processing of the entire image described above will be described.

Each modified embodiment to be described below is provided with a unit for recognition of the input image area by separating it into prescribed image types and performs the total toner amount reduction processing based on the image formation conditions according to the recognized image types.

As a first modified embodiment, a unit for recognition of a figure or character area and a photograph area of the input image is added, and processing for automatic adjustment of the toner amount according to the image formation conditions for the recognized image types will be described.

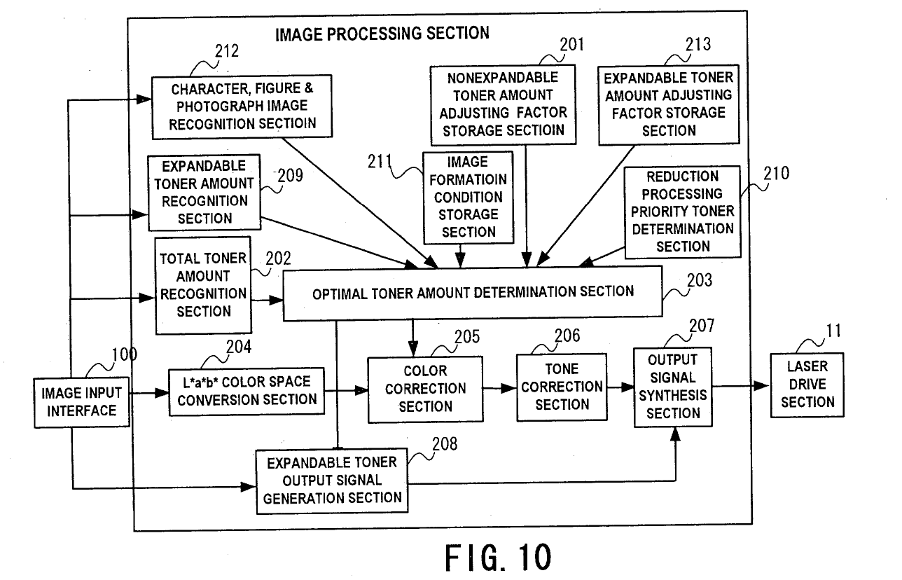

FIG. 10 is a block diagram showing a second control structure of the image processing section according to the present invention.

The figure is a block diagram showing the configuration having a character, figure and photograph image recognition section 212 and an image formation condition storage section 211 added to the first control structure shown in FIG. 2.

The character, figure and photograph image recognition section 212 recognizes the input image as respective areas of photographs, figures and characters, obtains the pixel information about the recognized respective areas and sends to the optimal toner amount determination section 203.

Here, a method of recognizing the input image by separating into the respective image areas of photographs, figures and characters is performed by conventional technologies such as a method of judging from a difference in color tone between the neighboring pixels of the input image, separately analyzing the image information which is described in a page description language or the like by previously dividing into image types.

The image formation condition storage section 211 has the priority for the reduction of the expandable toner amount and the nonexpandable toner amount previously defined and managed for classification of the respective image types recognized by the character, figure and photograph image recognition section 212.

The optimal toner amount determination section 203 obtains optimal parameters from the nonexpandable toner amount adjustment factor storage section 201 and the expandable toner amount adjustment factor storage section 213 on the basis of the recognition result from the total toner amount recognition section 202, the image types recognized by the character, figure and photograph image recognition section 212 and the processing conditions obtained by the image formation condition storage section, outputs an adjustment signal to the expandable toner output signal generation section 208 and outputs a UCR rate for reduction of the nonexpandable toner amount to the color correction section 205.

Then, processing for automatic adjustment of the total toner amount on the basis of the result of separating the input image into the image types of the figure, photograph and character areas shown in the block diagram of FIG. 10 will be described.

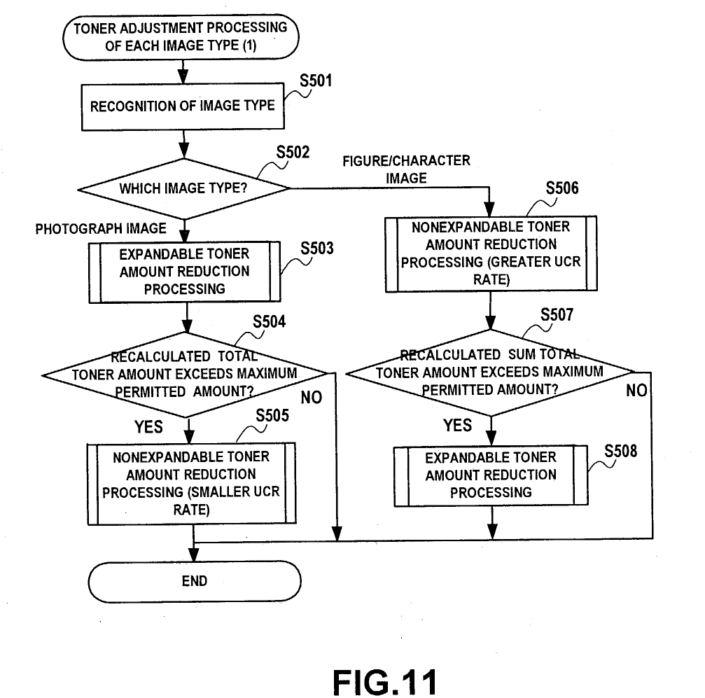

FIG. 11 is a flow chart showing the processing for reduction of the total toner amount on the basis of the image formation conditions according to the recognized image types (photograph, figure and character).

Here, to perform the processing according to the flow chart of FIG. 11, an image formation condition stored in the image formation condition storage section 211 is set to largely reduce the expandable toner amount to give priority to the image quality when a photograph image is processed, but it is previously set to largely reduce the nonexpandable toner amount when a character image is processed because high image quality is not required.

The character, figure and photograph image recognition section 212 recognizes the input image according to the image types and outputs the recognized image type and the pixel information belonging to the image type to the optimal toner amount determination section 203 (step S501).

When the recognized image type is a photograph image (photograph image in step S502), processing for reduction of the expandable toner amount is performed (step S503).

When the processing for reduction of the expandable toner amount results in that the recalculated total toner amount exceeds the maximum permitted amount (YES in step S504), the nonexpandable toner amount is reduced (step S505).

Meanwhile, when the image type recognized in step S502 is a figure and character image (the figure and character image in step S502), the nonexpandable toner amount is reduced (step S506).

When the processing for reduction of the nonexpandable toner amount results in that the recalculated total amount exceeds the maximum permitted amount (YES in step S507), the expandable toner amount is further reduced (step S508).

The nonexpandable toner amount adjustment factor used in step S505 and step S506 is a nonexpandable toner amount adjustment factor for adjusting the UCR amount to a smaller level when the photograph image is processed and a nonexpandable toner amount adjustment factor for adjusting the UCR amount to a larger level when the figure and character image is processed.

Then, a procedure by which colors of the input image are discriminated and the total toner amount is reduced according to the image formation conditions of the discriminated colors will be described.

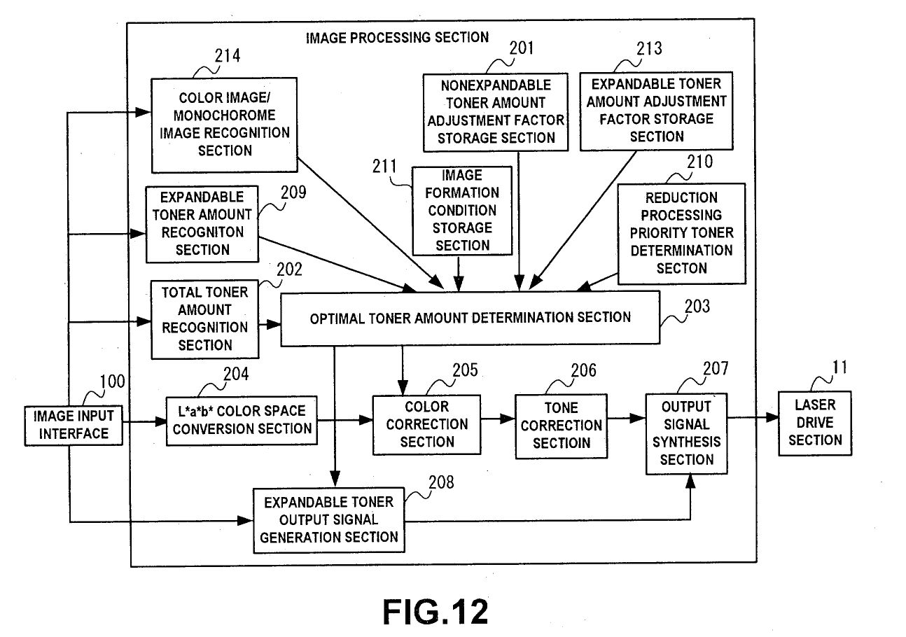

FIG. 12 is a control block diagram showing a third structure of the image processing section 200.

This figure is a control block diagram showing a structure having a color image and monochrome image recognition section 214 provided instead of the character, figure and photograph image recognition section 212 in the second structure shown in FIG. 10.

The color image and monochrome image recognition section 214 judges a color (a color image or a monochrome image) designated by the input image, obtains pixel information on each of the judged respective image areas and outputs the recognition results to the optimal toner amount determination section 203.

Here, the method of discrimination between the monochrome image and the color image is performed by a method applying a known technology of judging by an a*b* value at the time of conversion of CMYK and RGB signals into an L*a*b* color space in the color expression form used for the input image.

The image formation condition storage section 211 previously stores conditions using a nonexpandable toner amount adjustment factor for performing UCR specialized in the monochrome image capable of using the expandable toner amount as large as possible while reducing the nonexpandable toner amount by increasing the UCR amount when the recognition result of the input image is a monochrome image.

When the input image is a color image, the image formation condition storage section 211 previously stores setting for obtaining a UCR amount specialized in the color image so to restrain the image quality from being degraded by UCR as much as possible.

On the basis of the recognition result from the color image and monochrome image recognition section 214, the optimal toner amount determination section 203 performs processing for reduction of the total toner amount according to the processing conditions from the image formation condition storage section 211, outputs the adjustment signal on the basis of the determined expandable toner amount adjustment factor to the expandable toner output signal generation section 208 and sends the UCR rate based on the nonexpandable toner amount adjustment factor to the color correction section 205.

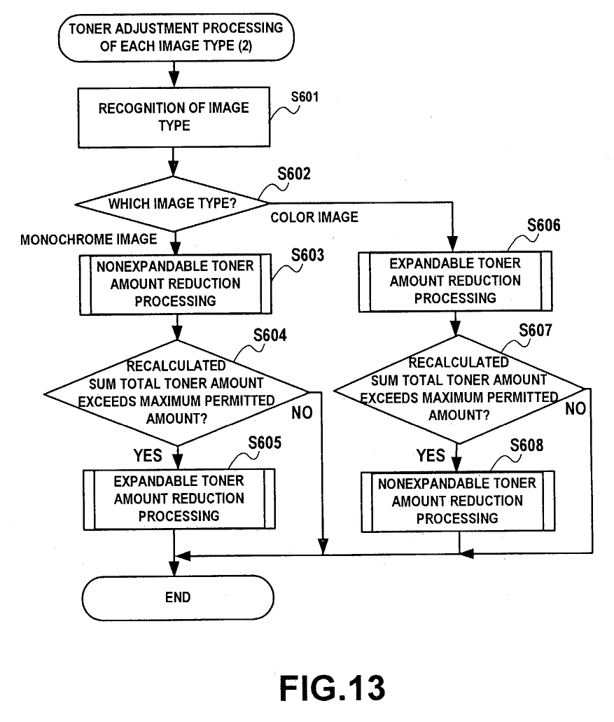

FIG. 13 is a flow chart showing processing for reduction of the total toner amount on the basis of the image formation conditions according to the recognized image type (monochrome image or color image).

Here, in the processing shown in the figure, as the image formation conditions previously stored in the image formation condition storage section 211, the processing conditions for preferential reduction of the nonexpandable toner amount in processing the monochrome image and the processing conditions for reduction of the expandable toner amount largely in processing the color image are previously determined.

The color image and monochrome image recognition section 214 recognizes whether the input image is a color image or a monochrome image and sends the recognized image type and the pixel information belonging to the image type to the optimal toner amount determination section 203 (step s601).

When the recognized image type is a monochrome image (monochrome image in step S602), the nonexpandable toner amount is reduced (step S603).

When the processing for reduction of the nonexpandable toner amount results in that the recalculated total toner amount exceeds the maximum permitted amount (YES in step S604), the expandable toner amount is reduced (step S605).

Meanwhile, when the image type recognized in step S602 is a color image (color image in step S602), the expandable toner amount is reduced (step S606).

When the processing for reduction of the expandable toner amount results in that the recalculated total amount exceeds the maximum permitted amount (YES in step S607), the nonexpandable toner amount is further reduced (step S608).

The nonexpandable toner amount adjustment factor used in step S603 and step S608 is a nonexpandable toner amount adjustment factor for adjustment of the UCR amount to a smaller level when the color image is processed and a nonexpandable toner amount adjustment factor for largely reducing the UCR amount or the black color toner amount when the monochrome image is processed.

Then, a fourth control structure configured including the image type recognition section for recognition of a prescribed image type by the character, figure and photograph image recognition section 212 and the color image and monochrome image recognition section 214 shown in the respective control blocks shown in FIG. 10 and FIG. 12, an image formation condition storage section, a representative image type determination section and a coverage recognition section, which are capable of dealing with a case in that the recognized image types are coexisting, will be described with reference to its block diagram and a flow chart of its processing.

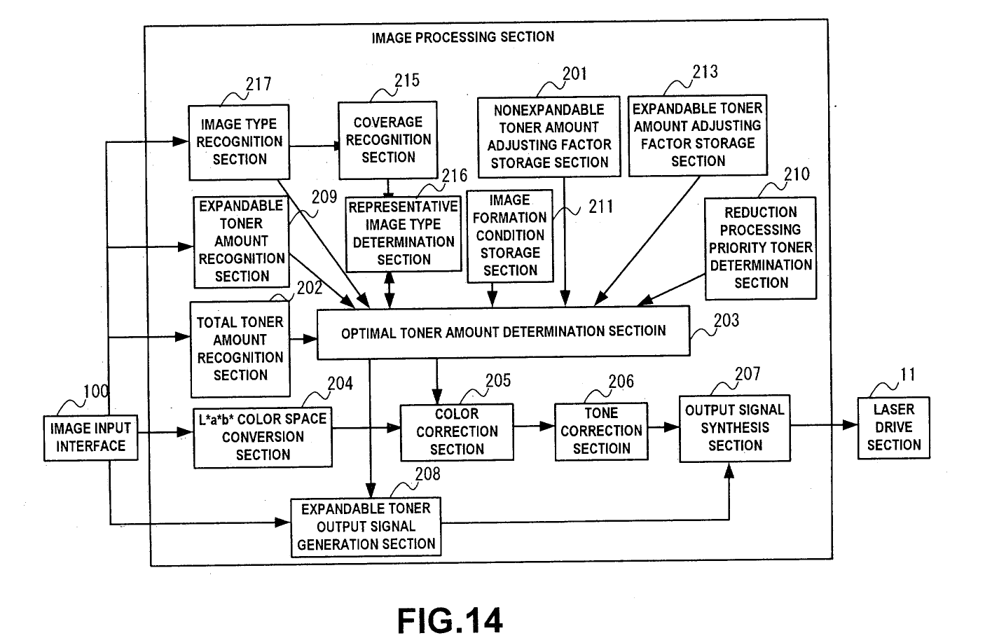

FIG. 14 is a block diagram showing the fourth control structure of the image processing section 200.

The figure is a control block diagram configured, in addition to the structure shown in FIG. 2, by providing an image type recognition section 217 for recognition of the input image by a prescribed image type, a coverage recognition section 215 for calculation of the coverage or occupied area of each recognized image type and a representative image type determination section 216 for determination of a representative image type if there are plural image types.

The image type recognition section 217 recognizes a prescribed image type required for image processing including discrimination of the figure, character or photograph image and whether the image is monochrome or chromatic, followed by obtaining image information related to the recognized area.

The coverage recognition section 215 calculates the coverage of each image type recognized by the image type recognition section 217 in the entire input image.

When plural image types are detected by the image type recognition section 217, the representative image type determination section 216 decides a representative image type required for the processing of reducing the total toner amount on the basis of the conditions set by the image formation condition storage section 211 and sends to the optimal toner amount determination section 203.

The optimal toner amount determination section 203 reduces the total toner amount on the basis of the recognition result from the total amount recognition section 209, the representative image type noticed by the representative image type determination section and the processing conditions set for the image formation conditions.

Then, procedures by which the image formation conditions are determined according to the recognized image type and the combination pattern of their coexistence and processing for adjustment of the toner amount of each image type is performed will be described.

The image type recognition section 217 recognizes an image type of the input image and outputs the recognized image type to the optimal toner amount determination section 203. When the input image is composed of several image areas, an image type of each image area is recognized. (step S701).

The optimal toner amount determination section 203 checks the number of image types contained in the input image. When the image type is single (No in step S702), it obtains the image formation conditions according to the recognized image type from the image formation condition storage section 211 and reduces the total toner amount.

Meanwhile, when plural image types are notified (YES in step S702), the image formation condition storage section 211 judges whether or not the toner amount is adjusted for each of the recognized image types.

When it is necessary to adjust the toner amount in the area of each image type (YES in step S703), the toner adjustment processing is repeatedly performed in the unit of the recognized image type (steps S707, S708). Meanwhile, when plural image types are recognized and the toner amount is adjusted based on the image formation conditions of the typical image type (NO in step S703), the image formation conditions corresponding to the image types notified by the representative image type determination section 216 is obtained (step S705), and the toner adjustment processing of the image area of each image type is performed based on the determined image formation conditions (step S706).

The method of determination of the representative image type to be processed in step S705 may be decided by storing the order of priority set for each combination of the mixed image types in advance in addition to the above-described coverage in the image formation condition storage section 211.

Then, processing for optimization of the toner amount by calculating the nonexpandable toner reduction amount and the expandable toner reduction amount by a pre-defined function will be described.

As an example of optimization of the toner amount by a function, the expandable toner adjustment factor sends its output so as to keep the designated amount of the expandable toner as it is, when the maximum value of the total amount of the nonexpandable toner does not exceed a prescribed reference value determined by the function, and the UCR rate for obtaining a prescribed UCR amount is sent for the nonexpandable toner.

Meanwhile, when the maximum value of the total nonexpendable toner amount exceeds a prescribed reference value, the UCR rate for obtaining a fixed UCR amount is sent regardless of the total nonexpandable toner amount, the expandable toner amount adjustment factor for obtaining a reduced amount of the expandable toner is sent by weighting so that the total toner amount is held in a range that not exceeding the reference value determined by a function to ensure the relative compressed height among the pixels of the image.

Here, when the image processing apparatus performs embossed print processing with two color toners (black toner and expandable toner), the UCR amount does not contribute. Therefore, a function for calculating the expandable toner amount adjustment factor having the maximum value of two color toners as an input parameter is applied. Thus, when a factor for determining the total toner amount is used as an input variable and the output result of the function can obtain information for reduction of the toner amount, the procedure is not exclusive.

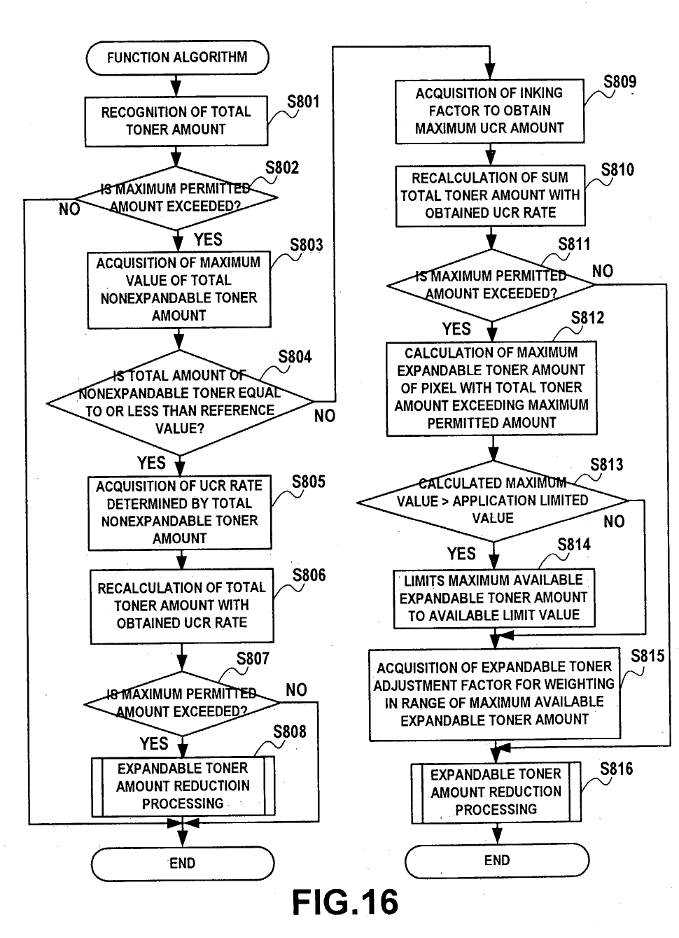

FIG. 16 is a flow chart showing an algorism when the automatic adjustment of the toner amount is performed by obtaining a UCR rate and an expandable toner amount adjustment factor by a function having the total nonexpandable toner amount as a parameter.

The total toner amount recognition section 202 recognizes the total toner amount of each pixel of the input image (step S801).

When there is no pixel with the total toner amount exceeding the maximum permitted amount (NO in step S802), the automatic adjustment processing of the toner amount is terminated.

When there is a pixel with the total toner amount exceeding the maximum permitted amount (YES in step S802), an image having the maximum nonexpandable toner amount in the image to be processed is obtained (step S803).

When the obtained nonexpandable toner amount of the pixel does not exceed a prescribed reference value (YES in step S804), a UCR rate corresponding to the maximum value of the obtained nonexpandable toner amount is obtained (step S805).

The total toner amount is recalculated by the obtained UCR rate (step S806) to judge whether the recalculated total toner amount exceeds the maximum permitted amount (step S807).

When the total toner amount exceeds the maximum permitted amount (YES in step S807), the expandable toner amount is reduced (step S808).

Meanwhile, when the procedure returns to step S804 and the maximum value of the nonexpandable toner amount exceeds the reference value (NO in step S804), a UCR rate for having the maximum UCR amount is obtained (step S809), and the total toner amount is recalculated with this obtained UCR rate (step S810).

When the recalculated total toner amount exceeds the maximum permitted amount (YES in step S8 11), the expandable toner amount of the pixel with the total toner amount exceeding the maximum permitted amount is calculated (step S812).

At this time, when the calculated maximum value exceeds the maximum available amount of the expandable toner of one pixel (YES in step S813), the available permitted value of the expandable toner amount is set as the maximum value (step S814).

In all the image areas to be processed, the expandable toner amount adjustment factor capable of compressing a height by weighting in a range of maximum available expandable toner amount of each pixel is obtained (step S815).

The expandable toner amount is reduced by the obtained expandable toner amount adjustment factor (step S816).

By storing a function for realizing the algorithm indicated by the above processing procedure in, for example, the image formation condition storage section 211 and adding a recognition section for recognizing the maximum value of the nonexpandable toner amount, it becomes possible to reduce the total toner amount considering both the nonexpandable toner amount and the expandable toner amount at the same time.

The variable used in the function shown in FIG. 16 is not limited to the total nonexpandable toner amount as far as it is an element required for calculation of the total toner amount.

The above function shows an example of determining the image formation conditions to be applied to the entire input image, but it may be configured to enable the adjustment of each of particular image types by preparing several functions for each image formation condition for the image type and using for each image type or by adding an image type to the input parameter of the function.

The above description includes the first to fourth control structures of the image processing section of the image processing apparatus of the present invention and the processing of the image program therefor.

For the above-described automatic adjustment processing of the toner amount, it is also possible to configure so as to allow the user to preview the area to which the image formation condition is applied and its conditions and, if necessary, to allow the user to make a change through the user interface.

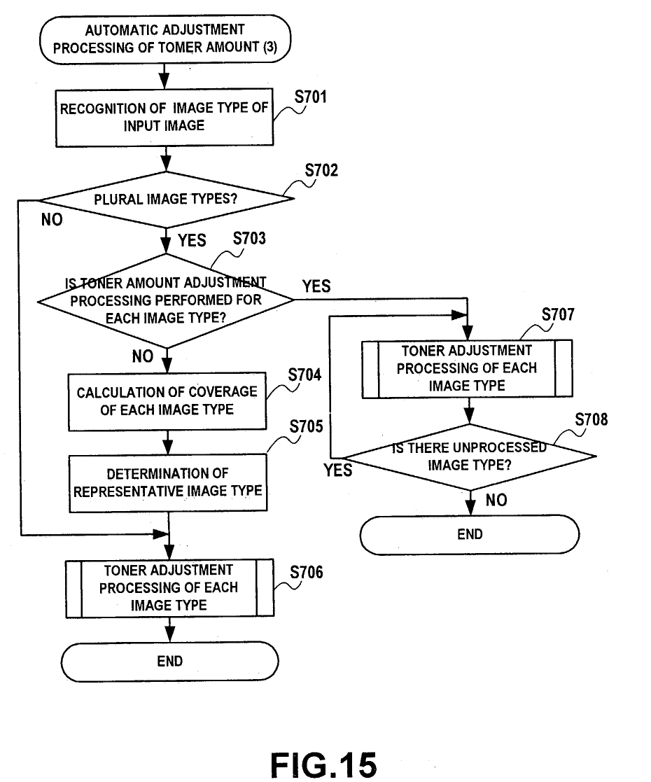

It may also be configured to provide the image processing program of the present invention shown in FIG. 5, FIG. 6, FIG. 7, FIG. 9, FIG. 11, FIG. 13, FIG. 15 and FIG. 16 as a printer driver to an apparatus other than the image processing apparatus 1, e.g. the PC 2 of FIG. 1.

It may also be configured that, when the system structure of image processing is subjected to the image processing by a host apparatus on line, the image processing program of the present invention is provided as a printer driver for the host apparatus to perform image processing.

What is claimed is:

1. An image processing apparatus for processing image information to form an embossed print image by transferring an image with an expandable toner and an image with a nonexpandable toner onto a recording medium and fixing the expandable toner and the nonexpandable toner to the recording medium, comprising:
a total toner amount recognition unit which recognizes a total toner amount of an expandable toner amount and a nonexpandable toner amount used for formation of an image in a unit of prescribed amount; and
an image processing unit which performs image processing of the image information to reduce the toner amount used for formation of the image when the total toner amount recognized by the recognition unit exceeds a prescribed amount.

2. The image processing apparatus according to claim 1, wherein the unit of prescribed amount is a pixel unit.

3. The image processing apparatus according to claim 1, wherein the unit of prescribed amount is a page unit.

4. The image processing-apparatus according to claim 1, wherein:
the nonexpandable toner includes a black toner, and
when the total toner amount recognized by the total toner amount recognition unit exceeds the prescribed amount, the image processing unit performs image processing to reduce the total toner amount by preferentially reducing the amount of the nonexpandable toner other than the black toner.

5. The image processing apparatus according to claim 1, wherein:
when the total toner amount recognized by the total toner amount recognition unit exceeds the prescribed amount, the image processing unit performs image processing to reduce the total toner amount by preferentially reducing the amount of the expandable toner.

6. The image processing apparatus according to claim 1, further comprising:
a determination unit which determines which amount of the expandable toner and the nonexpandable toner is preferentially reduced when the total toner amount recognized by the total toner amount recognition unit exceeds the prescribed amount, wherein:
the image processing unit performs image processing to reduce the total toner amount by reducing the amount of the toner determined by the determination unit.

7. The image processing apparatus according to claim 6, further comprising:
a type recognition unit which recognizes a type of the image information, wherein:
the determination unit determines according to the type of the image information recognized by the type recognition unit.

8. The image processing unit according to claim 7, further comprising:
an identification unit which identifies a type representing the image information when there are plural types of image information to be recognized by the type recognition unit, wherein:
the determination unit determines according to the type of the image information identified by the identification unit.

9. The image processing apparatus according to claim 8, wherein the identification unit identifies a type of image information having a largest area occupying the image information.

10. The image processing apparatus according to claim 7, wherein the type of image information is a character and figure image or a photograph image.

11. The image processing apparatus according to claim 10, wherein, when the type of image information recognized by the type recognition unit is the character and figure image, the determination unit determines to preferentially reduce the amount of nonexpandable toner.

12. The image processing apparatus according to claim 7, wherein the type of image information is a monochrome image or a color image.

13. The image processing apparatus according to claim 12, wherein when the type of image information recognized by the type recognition unit is the monochrome image, the determination unit determines to preferentially reduce the amount of nonexpandable toner.

14. An image processing method for processing of image information to form an embossed image by transferring an image with an expandable toner and an image with a nonexpandable toner onto a recording medium and fixing the expandable toner and the nonexpandable toner to the recording medium, comprising:
recognizing a total toner amount of an expandable toner amount and a nonexpandable toner amount used for formation of an image in a unit of prescribed amount by a total toner amount recognition unit; and
performing image processing of the image information to reduce the toner amount used for the image formation when the total toner amount recognized by the total toner amount recognition unit exceeds a prescribed amount.

15. An image processing program for processing image information to form an embossed print image by transferring an image with an expandable toner and an image with a nonexpandable toner onto a recording medium and fixing the expandable toner and the nonexpandable toner, which are transferred onto the recording medium, to the recording medium, comprising:
a step of recognizing a total toner amount of an expandable toner amount and a nonexpandable toner amount used for formation of an image in a unit of prescribed amount; and
a step of performing image processing of the image information to reduce the toner amount used for formation of the image when the total toner amount exceeds a prescribed amount.
